(19) United States
(12) Patent Application Publication
(10) Pub. No.: US 2013/0067195 A1
(43) Pub. Date: Mar. 14, 2013

(54) CONTEXT-SPECIFIC STORAGE IN MULTI-PROCESSOR OR MULTI-THREADED ENVIRONMENTS USING TRANSLATION LOOK-ASIDE BUFFERS

(71) Applicants: Kapil Sundrani, Bangalore (IN); Chethan Tatachar, Bangalore (IN)

(72) Inventors: Kapil Sundrani, Bangalore (IN); Chethan Tatachar, Bangalore (IN)

(73) Assignee: LSI CORPORATION, Milpitas, CA (US)

(21) Appl. No.: 13/228,053

(22) Filed: Sep. 8, 2011

(51) Int. Cl. G06F 12/10

(52) U.S. Cl. 711/207; 711/206; 711/E12.061

(57) ABSTRACT

A method for maintaining context-specific symbols in a multi-core or multi-threaded processing environment may include, but is not limited to: partitioning a virtual address space into at least one portion associated with the storage of one or more context-specific symbols accessible by at least a first processing core and a second processing core; defining at least one context-specific symbol; storing the at least one context specific symbol to the at least one portion of the virtual address space; and mapping the virtual address of the at least one context-specific symbol to both a physical address associated with the first processing core and a physical address associated with the second processing core.

### BACKGROUND

For ensuring safety in multi-processor or multi-threaded environments, global and static variables used in the code should be configured for simultaneous access and modification from different processors. To do this, various classes of global and static variables may be defined: 1) variables that can be specific to a thread of execution or execution context in a multi-processor environment (we call them context-specific) and those that are shared between different execution contexts (we call them shared).

For example: Consider a global variable, “foo” of type integer. By program logic, assume, this variable can be context-specific in a program that runs on multiple processors. If multiple contexts want to store context specific values in “foo”, the name “foo” cannot be used in the global namespace.

One approach to solve this problem is to use different symbol names, one for each processor. For example, “fooCore0” and “fooCore1” may be which point to resource instances for a processing Core 0 and a processing Core 1, respectively.

At run-time, it may be possible to determine which processor the code is running on, by using a run-time switch to identify the processor (e.g. via a processor-identifier variable), so that a context specific switch to use the appropriate variable can be made.

Using the above example of the variable “foo”, context-based variable identification may proceed as:
if(processor-identifier==Core0)
{Use fooCore0}
else if (processor-identifier==Core1)
{Use fooCore1}

This approach increases the number of symbols by n-fold thereby degrading code readability, if n-way scaling (i.e. run in parallel on n processors) is to be achieved. If this code is to be run on more than n-processors in-parallel, code modification is required (e.g. additional processor-identifier switch variables may be needed). It also requires code to be modified at each place where a context-specific variable is accessed. Hence, this approach does not scale well for multiple cores.

Another approach is to partition the symbol by the number of cores, using the processor-identifier as an index to access context-specific data. Taking the example stated above, context based variable identification may proceed as:
“int foo[n]”

Although it lessens the number of symbols, it suffers from the other problems mentioned in the previous example. It is also usually cache inefficient. For example, if indices foo[i] and foo[i+1] (0<=i, i+1<NUM_CORES) map to the same cache buffer, an update from one of the processors on index “i” (i.e. foo[i]) invalidates the neighboring entry foo[i+1] which is accessed from a neighboring processor and may be cached in the neighboring processor's cache.

Alternately, Thread Local Storage (TLS) is a method for using context-specific static and global variables that are local to a thread of execution. This allows context-specific statics and global variables to have same symbol in the global namespace and greatly simplifies program design and development. TLS may apply equally well when the number of processors increase, thereby providing for scalability of the program to run “safely” on more than one processor.

With TLS support, such context-specific variables can be tagged as thread-local at declaration and need not be changed at all the places they are accessed inside a program segment that runs on multiple processors. The run-time environment takes care of providing local copies at execution time. Creating Thread Local copies of context-specific variables is achieved through special support from architecture and/or runtime environment. For example, for achieving Thread Local Support: 1) Language provides support by recognizing “_thread” keyword; 2) Architecture provides support by defining register sets for efficient access (Example: thread pointer register, in IA64); 3) Compiler provides support by generating code to access a TLS variable, relative to the thread pointer (“tp-relative addressing”); 4) Linker, statically, provides support by aggregating all the TLS variables in a separate section that can be later relocated dynamically. Dynamic Linker/Loader provides support by relocating the references to TLS variable at run-time to a thread-specific area.

However, in environments where the run-time support for thread-local storage is not available (example: embedded environments, which have multiple processors to execute but share other hardware resources, such as memory, and either run an embedded OS or none at all), it may become difficult to realize the advantages of TLS to design or port code to run on multiple processors.

### SUMMARY

The present disclosure describes systems and methods for simulating context specific variables similar to TLS in environments where the run-time support for thread-local storage is not available in order to realize the advantages of TLS.

A method for maintaining context-specific symbols in a multi-core/processor or multi-threaded processing environment may include, but is not limited to: partitioning a virtual address space into at least one portion associated with the storage of one or more context-specific symbols accessible by at least a first processing core and a second processing core; defining at least one context-specific symbol; storing the at least one context specific symbol to the at least one portion of the virtual address space; and mapping the virtual address of the at least one context-specific symbol to both a physical address associated with the first processing core and a physical address associated with the second processing core.

### BRIEF DESCRIPTION OF THE DRAWINGS

The numerous advantages of the disclosure may be better understood by those skilled in the art by reference to the accompanying figures in which:

FIG. 1 shows a mapping of virtual and physical addresses for two processing cores.

FIG. 2 shows a mapping of the address space and generalized to N processors.

FIG. 3 shows an example of a method for storage in a multi-processor environment.

### DETAILED DESCRIPTION

The present invention proposes novel methods to realize TLS functionality through use of Translation Look-aside Buffers (TLBs) and Linker Support.

In the following detailed description, reference may be made to the accompanying drawings, which form a part hereof. In the drawings, similar symbols typically identify similar components, unless context dictates otherwise. The illustrative embodiments described in the detailed description, drawings, and claims may be not meant to be limiting. Other embodiments may be utilized, and other changes may be made, without departing from the spirit or scope of the subject matter presented here.

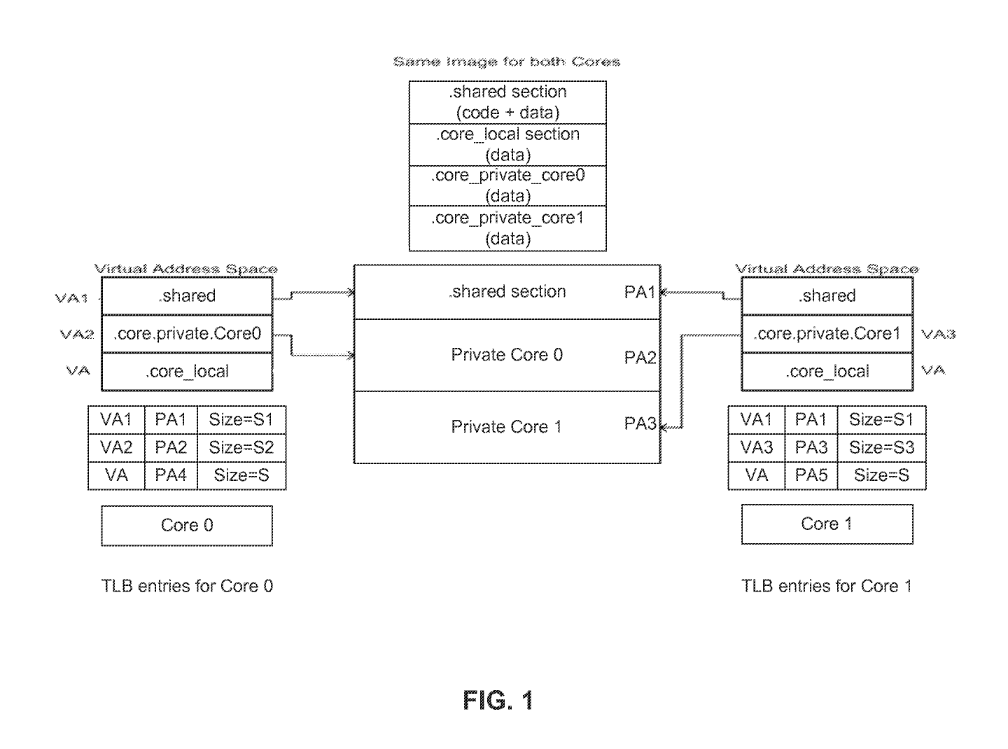

FIG. 1 shows the mapping of virtual and physical addresses for two processing cores Core 0 and Core 1. The virtual address space may be partitioned into four different sections, namely .shared, .core_local, .core_private_Core0 and .core_private_Core1 with virtual address ranges represented by VA1, VA, VA2 and VA3 respectively. The virtual address range VA1 is mapped to physical address range represented by PA1 on both the cores and is of size S1. The virtual address range VA2 is mapped to physical address range represented by PA2 on Core0 only and is of size S2. The virtual address range VA3 is mapped to physical address range represented by PA3 on Core1 only and is of size S3. The core_local virtual address range VA is of size S and is mapped to physical address range represented by PA4 on Core0 and physical address range represented by PA5 on Core1.

The .shared section may contain the global shared code and data that can be accessed from both cores. Since code is not modified at run-time, it can be placed in this section and any data that needs to be modified by both Core0 and Core1, may be placed in this section. If both cores need to modify any data in this section at the same time, it will need to be protected with locks to ensure data integrity.

The .core_private sections (e.g. .core_private_core0, .core_private_core1) may contain context-specific data (e.g. data that is specific to a given processor due to a specific functionality that runs only on that processor) and data in this section is not visible to the other processor. This is achieved by mapping VA2 on Core0 to PA2 and VA3 on Core1 to PA3. Since VA2 is not mapped on Core1, any variable placed in .core_private_Core0 section cannot be accessed on Core1. Similarly, since VA3 is not mapped on Core0, any variable placed in .core_private_Core1 cannot be accessed on Core0.

The .core_local section contains any data that needs to be accessed with the same virtual address but needs to hold different values, specific to different contexts on each core. This is achieved by using the same symbols/virtual addresses represented by VA across both cores but mapping VA to different physical address ranges PA4 and PA5 for Core0 and Core1 respectively. If the symbol “foo” is placed in this section, “foo” can be accessed on both cores but will touch different underlying physical addresses. As such, protection or locking is not needed to synchronize access.

In the above example, only two processor cores are considered, but the same example can be easily generalized to any number of processors. To extend the example to more than two processors, a new TLB entry for the .core_local section for each of the processors that use the same name “foo” may be created. All such processors will then share the same namespace with all other processors unaware of the physical memory of any of the other processors thereby providing for scalability

A new “.core_local” section, may be defined through a linker directive. For example, a new attribute (e.g. “_attribute”) such as “_CORE_LOCAL” may be defined and tagged to all symbols that are context-specific or point to resources that are context-specific. For example, the variable “foo” may be defined as:
int foo_CORE_LOCAL;

All symbols marked with attribute “_CORE_LOCAL” may be placed in a code section “.core_local.”

At program load time, the “.core_local” section may be loaded at different physical locations and mapped using TLB entries as shown in FIG. 1. In FIG. 1, only two processors are considered, but the same technique may be used on any number of processors.

Hence, even through the variable “foo” has the same virtual address in the program that runs on multiple cores (the same name in the global namespace), it is mapped to context-specific physical memory at program load-time, by using the TLB entries, which are specific to a processor.

In a multi-processing OS environment, run-time support by the OS is needed by use of a dynamic-linker-loader to map the TLS to individual threads' virtual address space on-the-fly at thread-creation time or access time. In environments where there is no such support from the runtime environment, the hardware support of TLB entries may be used to simulate TLS. This may be done by relocating the “context specific” section of a virtual address space of the program to different physical spaces at program load time as shown in FIG. 1.

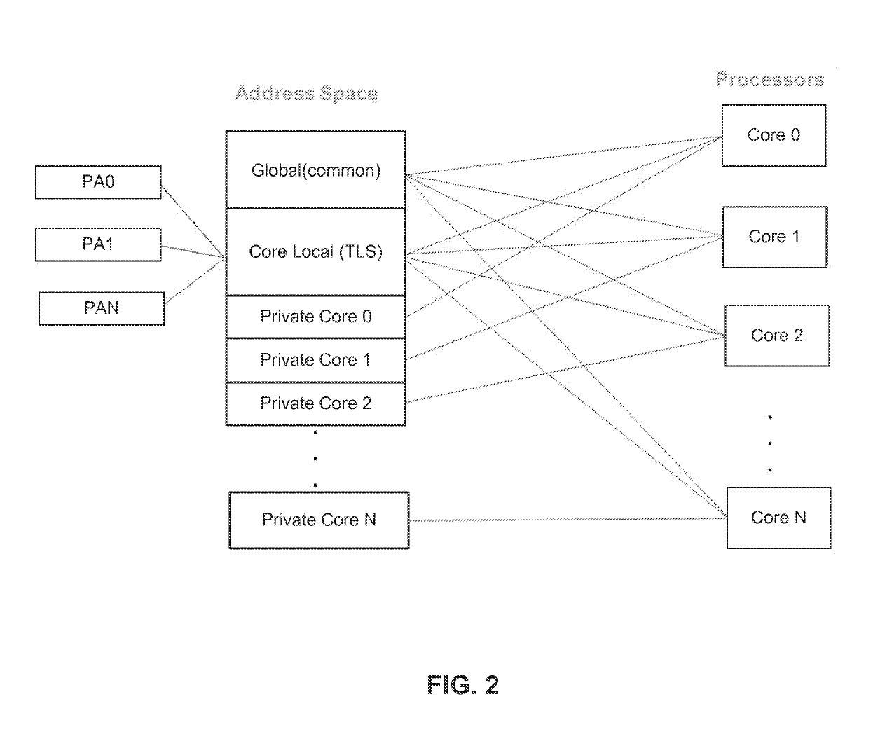

FIG. 2 shows the mapping of the address space and generalized to N processors. A portion of the address space may be mapped as global memory and is shared by different processors. Each of the processors can see the latest copy of data in such memory and the contents of this memory may be protected against simultaneous update by multiple processors (e.g. via locks).

A portion of the address space is mapped as “core local” where all context-specific structures are placed. All symbols in this section will have common virtual addresses across different cores (e.g. represented as VA) but a different underlying physical addresses for each core (denoted as PA 0, PA 1 . . . PA N), which are mapped to these physical locations using TLB entries which map VA to PA0 on processor0, VA to PA1 on processor1 and so on.

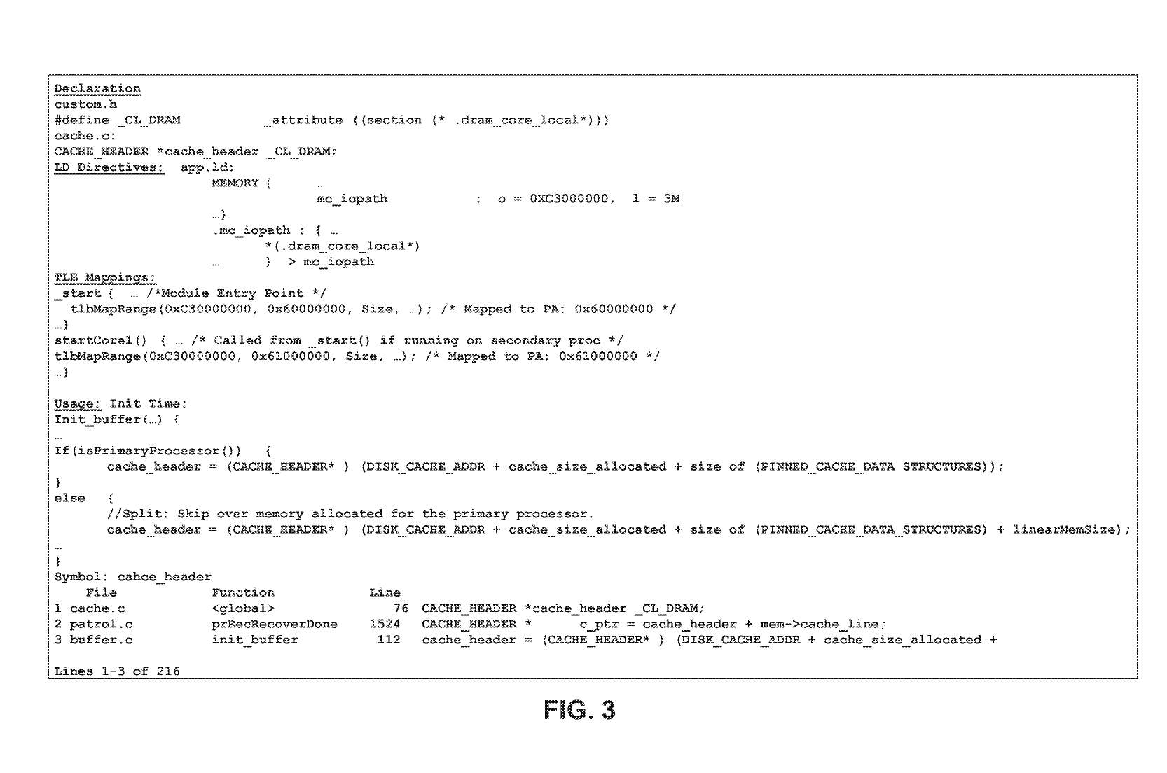

FIG. 3 depicts an example where “cache_header” is a context-specific variable and points to a region of memory that is specific to an execution context. _CL_DRAM is the keyword that is “tagged” to variables that are context-specific, (e.g. “cache_header” in this case). A new linker section (i.e. “.dram_core_local”) may be defined to hold all such variables. In the linker's directive file, the size (3MB) and the virtual address (0XC3000000) of the .dram_core_local section may be defined. At program load time the function “tlbMapRange( ) maps the virtual address of the “.dram_core_local” (in this example, this includes the virtual address of the symbol cache_header) to different physical addresses (e.g. 0x60000000 and 0x61000000) at program load time. The “Usage” section of FIG. 3 describes the usage scenario of the context-specific variable “cache_header”. Note that depending on the context of the processor, cache_header points to different physical memory, the instance for the second Processor (else part) being offset from the other by “linearMemSize”. Now all the other instances of cache_header need not be modified (e.g. the 216 such instances of FIG. 3) This is because, both the symbol “cache_header” at program load time (using TLB) and the memory that it points to at initialization time, are mapped to different physical addresses.

Even though the above discussion describes examples in the context of multi-processor systems, the design applies equally well to multi-threaded environments as well. Being lock free, the new technique provides for performance gain over methods that use locking (semaphores, etc) or use run time checks to determine which processor the code is running on.

It is believed that the present invention and many of its attendant advantages will be understood by the foregoing description. It may be also believed that it will be apparent that various changes may be made in the form, construction and arrangement of the components thereof without departing from the scope and spirit of the invention or without sacrificing all of its material advantages. The form herein before described being merely an explanatory embodiment thereof. It may be the intention of the following claims to encompass and include such changes.

The foregoing detailed description may include set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure.

In addition, those skilled in the art will appreciate that the mechanisms of the subject matter described herein may be capable of being distributed as a program product in a variety of forms, and that an illustrative embodiment of the subject matter described herein applies regardless of the particular type of signal bearing medium used to actually carry out the distribution. Examples of a signal bearing medium include, but may be not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, receiver, transmission logic, reception logic, etc.), etc.).

Those having skill in the art will recognize that the state of the art may include progressed to the point where there may be little distinction left between hardware, software, and/or firmware implementations of aspects of systems; the use of hardware, software, and/or firmware may be generally (but not always, in that in certain contexts the choice between hardware and software may become significant) a design choice representing cost vs. efficiency tradeoffs. Those having skill in the art will appreciate that there may be various vehicles by which processes and/or systems and/or other technologies described herein may be effected (e.g., hardware, software, and/or firmware), and that the preferred vehicle will vary with the context in which the processes and/or systems and/or other technologies may be deployed. For example, if an implementer determines that speed and accuracy may be paramount, the implementer may opt for a mainly hardware and/or firmware vehicle; alternatively, if flexibility may be paramount, the implementer may opt for a mainly software implementation; or, yet again alternatively, the implementer may opt for some combination of hardware, software, and/or firmware. Hence, there may be several possible vehicles by which the processes and/or devices and/or other technologies described herein may be effected, none of which may be inherently superior to the other in that any vehicle to be utilized may be a choice dependent upon the context in which the vehicle will be deployed and the specific concerns (e.g., speed, flexibility, or predictability) of the implementer, any of which may vary. Those skilled in the art will recognize that optical aspects of implementations will typically employ optically oriented hardware, software, and or firmware.

What is claimed is:

1. A computer implemented method for maintaining context-specific symbols in a multi-core or multi-threaded processing environment comprising:
partitioning a virtual address space into at least one portion associated with the storage of one or more context-specific symbols accessible by at least a first processing core and a second processing core;
defining at least one context-specific symbol;
storing the at least one context specific symbol to the at least one portion of the virtual address space; and
mapping the virtual address of the at least one context-specific symbol to both a physical address associated with the first processing core and a physical address associated with the second processing core.

2. The computer-implemented method of claim 1, wherein the storing the at least one context specific symbol to the at least one portion of the virtual address space comprises:
creating a translation look-aside buffer entry for the at least one partition associated with the context-specific symbol in at least one of the first processing core and the second processing core.

3. The computer-implemented method of claim 1, further comprising:
defining a data section associated with at least one of the first processing core and the second processing core; and
storing the data section associated with at least one of the first processing core and the second processing core to the at least one portion of the virtual address space.

4. The computer-implemented method of claim 3, wherein the defining a data section associated with at least one of the first processing core and the second processing core comprises:
defining a data section associated with at least one of the first processing core and the second processing core with a linker directive.

5. The computer-implemented method of claim 1, further comprising:
loading the at least one portion of the virtual address space; and
mapping the at least one portion of the virtual address space to a physical location associated with the first processing core and a physical location associated with the second processing core.

6. The computer-implemented method of claim 5, wherein the mapping the at least one portion of the virtual address space to a physical location associated with the first processing core and a physical location associated with the second processing core comprises:
mapping the at least one portion of the virtual address space to a physical location associated with the first processing core and a physical location associated with the second processing core according to a translation look-aside buffer entry associated with the at least one portion of the virtual address.

7. The computer-implemented method of claim 1, wherein the partitioning a virtual address space into at least one portion associated with the storage of one or more context-specific symbols accessible by at least a first processing core and a second processing core comprises:
partitioning the virtual address space into at least:
a first portion accessible by at least a first processing core and a second processing core;
a second portion accessible by only the first processing core; and
a third portion accessible by only the second processing core.

8. A system for maintaining context-specific symbols in a multi-core or multi-threaded processing environment comprising:
means for partitioning a virtual address space into at least one portion associated with the storage of one or more context-specific symbols accessible by at least a first processing core and a second processing core;
means for defining at least one context-specific symbol;
means for storing the at least one context specific symbol to the at least one portion of the virtual address space; and
means for mapping the virtual address of the at least one context-specific symbol to both a physical address associated with the first processing core and a physical address associated with the second processing core.

9. The system of claim 8, wherein the means for storing the at least one context specific symbol to the at least one portion of the virtual address space comprise:
creating a translation look-aside buffer entry for the at least one partition associated with the context-specific symbol in at least one of the first processing core and the second processing core.

10. The system of claim 8, further comprising:
means for defining a data section associated with at least one of the first processing core and the second processing core; and
means for storing the data section associated with at least one of the first processing core and the second processing core to the at least one portion of the virtual address space.

11. The system of claim 10, wherein the means for defining a data section associated with at least one of the first processing core and the second processing core comprise:
means for defining a data section associated with at least one of the first processing core and the second processing core with a linker directive.

12. The system of claim 8, further comprising:
means for loading the at least one portion of the virtual address space; and
means for mapping the at least one portion of the virtual address space to a physical location associated with the first processing core and a physical location associated with the second processing core.

13. The system of claim 12, wherein the means for mapping the at least one portion of the virtual address space to a physical location associated with the first processing core and a physical location associated with the second processing core comprise:
means for mapping the at least one portion of the virtual address space to a physical location associated with the first processing core and a physical location associated with the second processing core according to a translation look-aside buffer entry associated with the at least one portion of the virtual address.

14. The system of claim 8, wherein the means for partitioning a virtual address space into at least one portion associated with the storage of one or more context-specific symbols accessible by at least a first processing core and a second processing core comprise:
means for partitioning the virtual address space into at least:
a first portion accessible by at least a first processing core and a second processing core;
a second portion accessible by only the first processing core; and
a third portion accessible by only the second processing core.
